(19) United States
(12) Patent Application Publication
(10) Pub. No.: US 2003/0048240 A1
(43) Pub. Date: Mar. 13, 2003

(54) Capillary discharge plasma display panel having capillary of two size openings and method of fabricating the same

(75) Inventors: Bhum Jae Shin, Rutherford, NJ (US); Michael D. Martin, West New York, NJ (US); Steven Kim, Harrington Park, NJ (US)

Correspondence Address: MORGAN LEWIS & BOCKIUS LLP, 1111 PENNSYLVANIA AVENUE NW, WASHINGTON, DC, 20004, US

(73) Assignee: Plasmion Displays, LLC

(21) Appl. No.: 09/949,977

(22) Filed: Sep. 12, 2001

(51) Int. Cl. G09G 3/28

(52) U.S. Cl. 345/60

(57) ABSTRACT

A capillary discharge plasma display panel having a capillary of double size openings and method of fabricating the same is disclosed in the present invention. More specifically, a plasma display panel includes first and second substrates, a first electrode on the first substrate, a first dielectric layer on the first electrode, at least one second electrode on the second substrate, a second dielectric layer on the second electrode, wherein the second dielectric layer has at least one capillary therein, and the capillary comprises first and second openings and the first opening is greater than the second opening in a horizontal width, and at least one discharge space between the first and second dielectric layers and directly adjacent to the first opening of the capillary, thereby exposing a portion of the second electrode to the discharge space through the first and second openings to generate a continuous plasma discharge from the capillary.

### BACKGROUND OF THE INVENTOIN

1. Field of the Invention

The present invention relates to a plasma display panel, and more particularly, to a capillary discharge plasma display panel having a capillary of two size openings and method of fabricating the same. Although the present invention is suitable for a wide scope of applications, it is particularly suitable for achieving high brightness as well as high luminance efficiency in the capillary discharge plasma display panel.

2. Discussion of the Related Art

A plasma display panel (PDP) has been the subject of extensive research and development in the display industry because it can be realized as a thin and large size flat panel device. Both AC and DC-operated plasma display panel structures have been employed in operating the PDP.

A DC-operated PDP employs DC electrodes that are in direct contact with the gas, but has to employ current limiting devices such as a resistor in the drive circuit to prevent excessive current flow when the gas discharges. In order to confine the discharge area within a pixel, dielectric barriers are positioned between the pixel cells and prevent the cross talk due to the spread of the ionized gas.

As well known, a dielectric layer is the most commonly used insulating layer that prevents destructive arc discharge in the panel. A partial cross-sectional view of a conventional barrier type AC plasma display panel (PDP) is illustrated in FIG. 1. Referring to FIG. 1, the conventional barrier type AC PDP includes front and rear glass substrates 10 and 13 that enclose a discharge gas (not shown) filled in a discharge space 16. A first electrode 11 is formed on the front glass substrate 10. The first electrode 11 is completely covered with a first dielectric layer 12. Similarly, a second electrode 14 is formed on the rear glass substrate 13 and is completely buried by a second dielectric layer 15 in order to prevent arc discharge on the surface of the second electrode 14.

However, the conventional barrier type AC PDP generates low density plasma, resulting in low brightness and a slow response time due to a long discharge time on the dielectric wall.

### SUMMARY OF THE INVENTION

Accordingly, the present invention is directed to a capillary discharge plasma display panel having a capillary of two size openings and method of fabricating the same that substantially obviates one or more of problems due to limitations and disadvantages of the related art.

An object of the present invention is to provide a capillary discharge plasma display panel having a capillary of two size openings and method of fabricating the same that provides high brightness as well as a fast response time.

Additional features and advantages of the invention will be set forth in the description that follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a capillary discharge plasma display panel includes first and second substrates, a first electrode on the first substrate, a first dielectric layer on the first electrode, at least one second electrode on the second substrate, a second dielectric layer on the second electrode, wherein the second dielectric layer has at least one capillary therein, and the capillary comprises first and second openings and the first opening is greater than the second opening in a diameter, and at least one discharge space between the first and second dielectric layers and directly adjacent to the first opening of the capillary, thereby exposing a portion of the second electrode to the discharge space through the first and second openings to generate a efficient plasma discharge from the capillary.

In another aspect of the present invention, a method of fabricating a capillary discharge plasma display panel, having a pair of first and second substrates facing into each other with a discharge space therebetween, the method includes the steps of forming a first electrode on the first substrate, forming a first dielectric layer on the first substrate including the transparent electrode, forming at least one second electrode on the second substrate, forming a second dielectric layer on the second substrate including the second electrode, forming at least one first capillary in the second dielectric layer, and forming at least one second capillary in the second dielectric layer, wherein the first capillary is directly connected to the second capillary and the first capillary has end openings greater than the second capillary, thereby exposing a portion of the second electrode to the discharge space.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a partial cross-sectional view of a conventional barrier type AC plasma display panel (PDP);

FIG. 2 is a schematic cross-sectional view of a capillary discharge type plasma display panel according to a first embodiment of the present invention;

FIG. 3 is a partial cross-sectional view of the capillary discharge type plasma display panel of FIG. 2;

FIG. 4 is a partial cross-sectional view of a capillary discharge type plasma display panel according to a second embodiment of the present invention;

FIG. 5 is a partial cross-sectional view of a capillary discharge type plasma display panel according to a third embodiment of the present invention;

FIG. 6 is a graph of turn-on voltage v. discharge chamber pressure for various plasma display panel structures shown in FIGS. 1 to 5;

FIG. 7 is a graph of sustain voltage v. discharge chamber pressure for the various plasma display panel structures shown in FIGS. 1 to 5;

FIG. 8 is a graph of current for applied voltage and discharge chamber pressure for the various plasma display panel structures shown in FIGS. 1 to 5;

FIG. 9 is a graph of current v. sustain voltage for the various plasma display panel structures shown in FIGS. 1 to 5;

FIG. 10 is a schematic diagram of laser optics used in forming a capillary in a dielectric layer of the capillary discharge type plasma display panel in accordance with the present invention; and

FIGS. 11A to 11G are cross-sectional views illustrating fabricating process steps for a capillary discharge plasma display panel according to the present invention.

### DETAILED DESCRIPTION OF THE PREFERRED EMBODIMENTS

Reference will now be made in detail to the preferred embodiments of the present invention, examples of which are illustrated in the accompanying drawings.

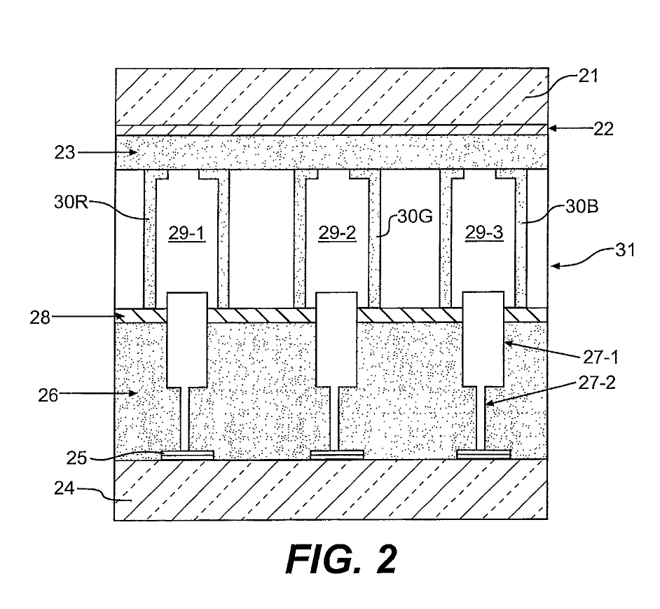

FIG. 2 is a cross-sectional view of a capillary discharge type plasma display panel in accordance with a first embodiment of the present invention. As shown in FIG. 2, a capillary discharge type plasma display panel includes a pair of front and rear substrates (21,24) with discharge spaces (29-1, 29-2, 29-3) therebetween.

For realizing a full color representation, three separate discharge spaces (29-1, 29-2, 29-3) representing R, G, and B are required in the unit pixel. UV-visible conversion layers (30R, 30G, 30B), such as phosphor, are deposited on the inner walls of each discharge space.

A transparent electrode (22), for example, indium tin oxide (ITO), is formed on the front substrate (21). A first dielectric layer (23), such as lead oxide (PbO), for AC driving is formed to cover the transparent electrode (22) and separates the transparent electrode (22) from the discharge spaces (29-1, 29-2, 29-3). Each discharge space is defined by a pair of barrier ribs (31) for the unit of light emitting areas.

On the rear substrate (24), second electrodes (25) are formed thereon and buried by a second dielectric layer (26). A thickness for the second dielectric layer (26) is preferably about 50 μm. A protective layer (28) made of magnesium oxide (MgO), for example, may be formed on the second dielectric layer (26).

Capillaries having first and second openings (27-1, 27-2) are formed in the second dielectric layer to generate capillary discharge plasma from the capillaries. The structure of the capillaries is critical in generating capillary discharge in the present invention. Thus, an optimum shape of the capillaries should be designed for maximizing a performance of the capillary discharge PDP.

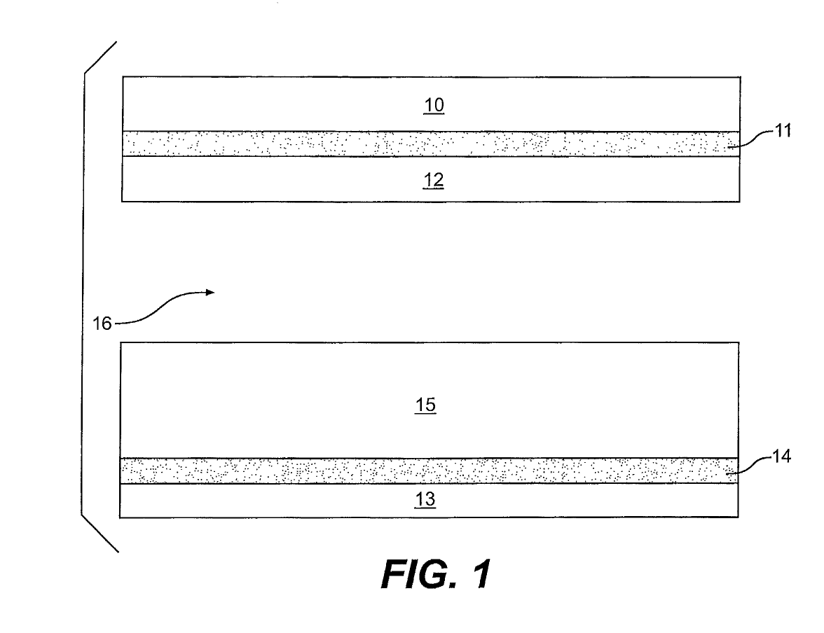

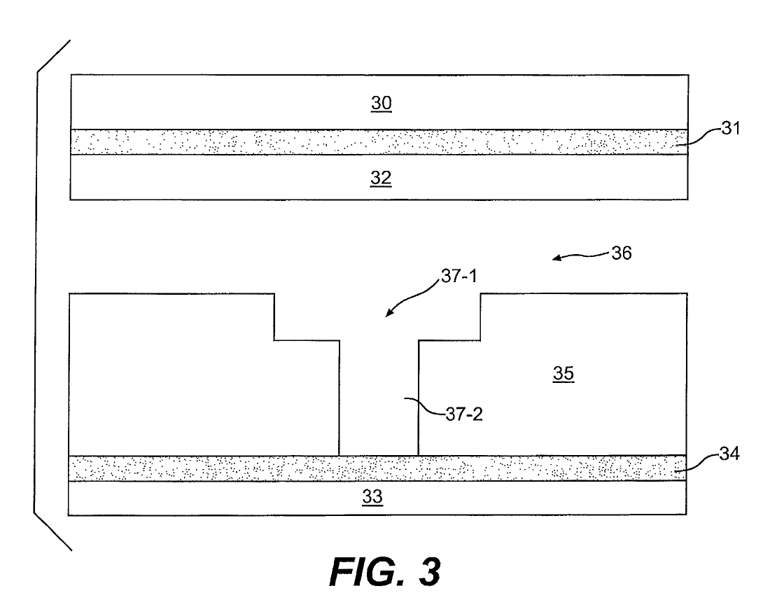

In order to demonstrate a feasibility of the capillary design, various shapes of the capillaries are compared to the conventional barrier type AC PDP, shown in FIG. 1. In the first embodiment for the capillary shape shown in FIG. 3, the first and second openings have horizontal widths in the ratio of 2 to 1. Preferably, the first opening (37-1) has a horizontal width of about 100 μm when a horizontal width of the second opening (37-2) is about 50 μm. Vertical depths of the first and second openings are in the ratio of 1 to 2 in the first embodiment. Thus, when a thickness of the second dielectric layer is about 50 μm, the first and second openings have vertical depths of about 17 μm and 33 μm, respectively.

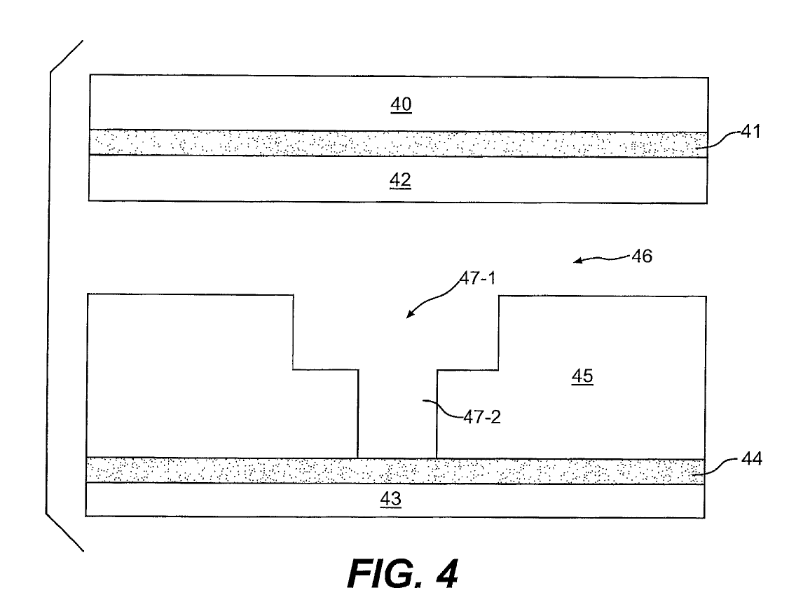

A second embodiment of the capillary geometry is shown in FIG. 4. Similar to the first embodiment, the first and second openings have horizontal widths in the ratio of 2 to 1. Preferably, the first opening (47-1) has a horizontal width of about 100 μm when a horizontal width of the second opening (47-2) is about 50 μm. Vertical depths of the first and second openings are in the ratio of 1 to 1 in the second embodiment. Thus, when a thickness of the second dielectric layer is about 50 μm, the first and second openings have vertical depths of about 25 μm and 25 μm, respectively.

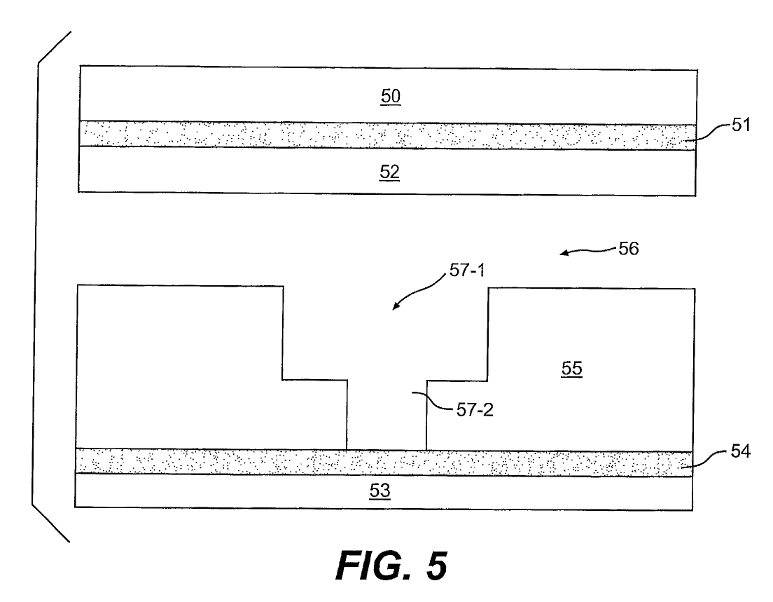

A third embodiment of the capillary geometry as shown in FIG. 5 is similar to the previous embodiments except for the vertical depth ratio of the first and second openings (57-1, 57-2). Vertical depths of the first and second openings are in the ratio of 2 to 1 in the third embodiment. For example, when a thickness of the second dielectric layer is about 50 μm, the first and second openings have vertical depths of about 33 μm and 17 μm, respectively.

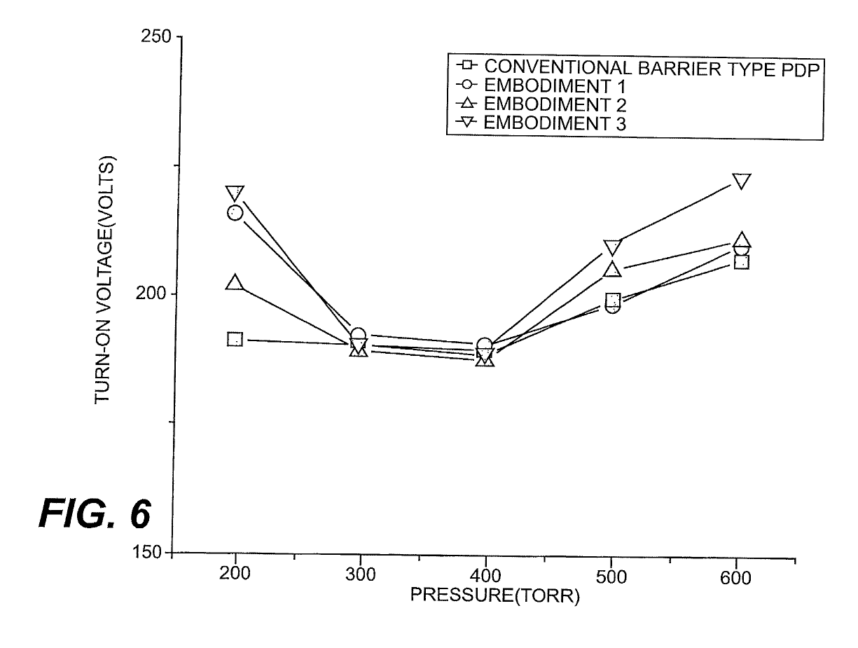

FIG. 6 is a graph of turn-on voltage v. discharge space pressure for various plasma display panel structures shown in FIGS. 1 to 5. As shown in the graph, a turn-on voltage for the conventional barrier type PDP is lower than that for the above-mentioned capillary shapes when the discharge pressure is about 200 Torr. However, at the discharge pressure in the range of about 300 to 500 Torr, a turn-on voltage becomes similar to one another. For example, at the discharge space pressure between 300 and 400 Torr, a turn-on voltage of the conventional barrier type PDP and that of the capillary discharge type PDP of the three different capillary shapes becomes about 180 V.

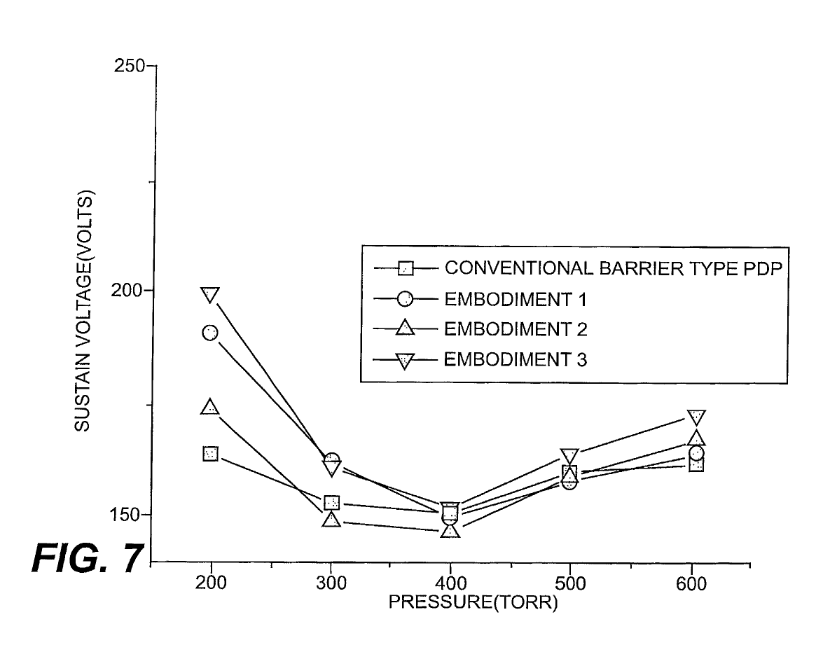

FIG. 7 is the graph of sustain voltage v. discharge pressure for the various plasma display panel structures shown in FIGS. 3 to 5. A sustain voltage for each capillary discharge type PDP is obtained between 150 and 175 V at the discharge space pressure of 300 to 600 Torr.

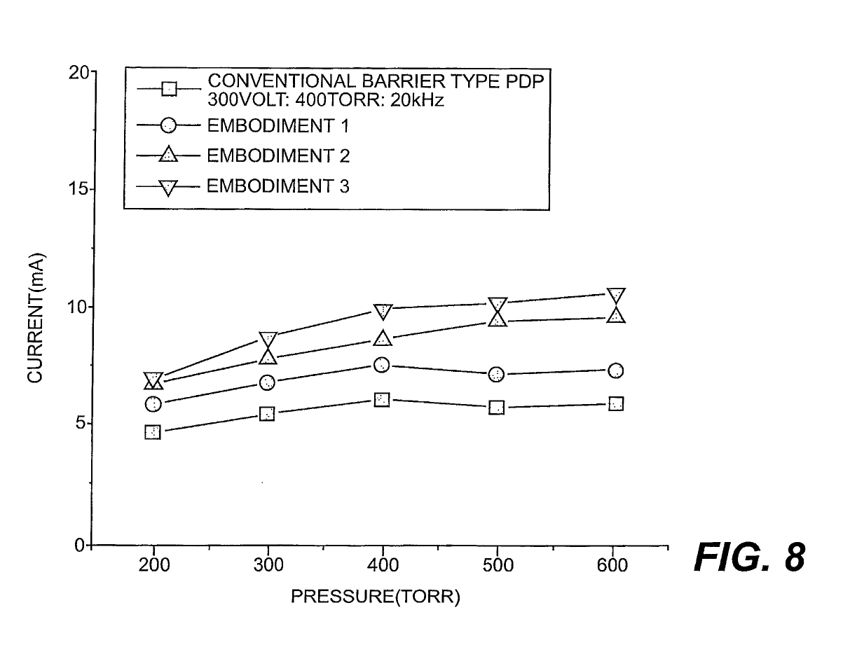

FIG. 8 is a graph of current for applied voltage and discharge space pressure for the various plasma display panel structures shown in FIGS. 3 to 5. When a voltage of 300 V at 20 kHz is applied, a current is measured at the different discharge space pressures. As shown in FIG. 8, a current change is not significant in the entire pressure range from 200 to 600 Torr. For the conventional barrier type PDP, a measured current varies in the range of 5 to 6 mA. The capillary discharge type PDP of the first embodiment generates a current higher than the conventional barrier type PDP. The capillary discharge type PDP of the third embodiment generates the highest current in the range of about 7 to 12 mA.

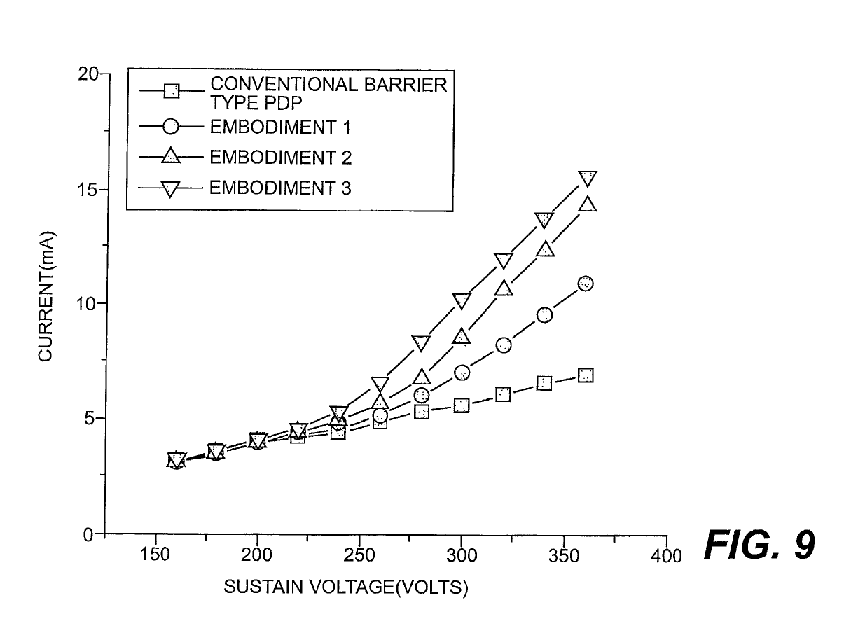

FIG. 9 is the graph of current v. sustain voltage for the various plasma display panel structures shown in FIGS. 3 to 5. As shown in FIG. 9, the conventional barrier type PDP has the lowest slope while the capillary discharge type PDP of the third embodiment has the highest slope. For example, a current of about 7 to 10 mA is generated with applying a voltage of about 300 V for the capillary discharge type PDPs of the present invention. However, the capillary in the dielectric layer according to the first to third embodiments exposing a portion of the electrode acts as a resistor, thereby providing a current-limiting effect.

In general, a discharge current increases with increasing a diameter of the capillary because a capillary having a large diameter is less effective in current-limiting than a capillary having a small diameter. As discussed previously, the capillary discharge type PDPs have turn-on and sustain voltages similar to the conventional barrier type PDP. However, the capillary discharge type PDPs generate a higher current than the conventional barrier type PDP.

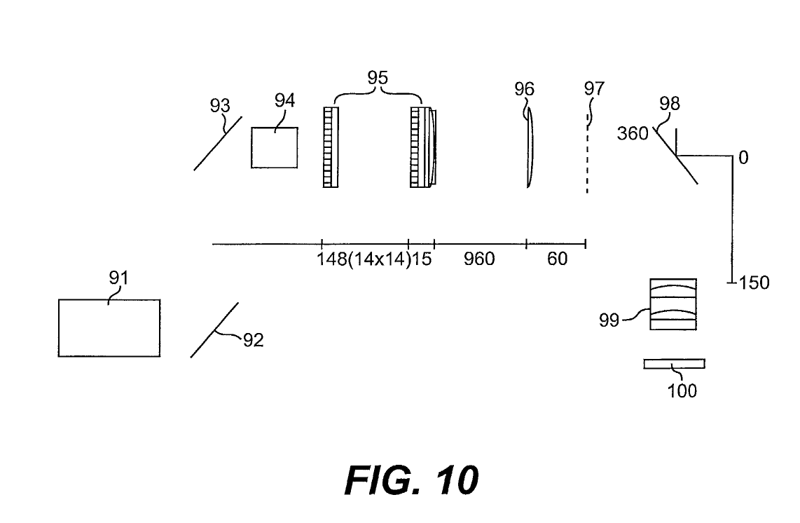

In FIG. 10, a schematic diagram of laser optics for forming a capillary is illustrated. Laser optics comprises a Krypton Fluoride (KrF) laser 91, first and second mirrors 92 and 93, an attenuator 94, a homegenizer 95, a field lens 96, a mask 97, a third mirror 98, and an objective 99. A substrate 100 is positioned below the objective 99. Process conditions are as follows: laser wavelength of 248 nm, 5×demagnification, laser fluence on substrate of 1.8 to 2.2 J/cm², and repetition rate of 50 Hz (pulse/sec).

A method of fabricating a capillary discharge plasma display panel having a capillary of two size openings according to the present invention will now be explained with reference to the accompanying drawings.

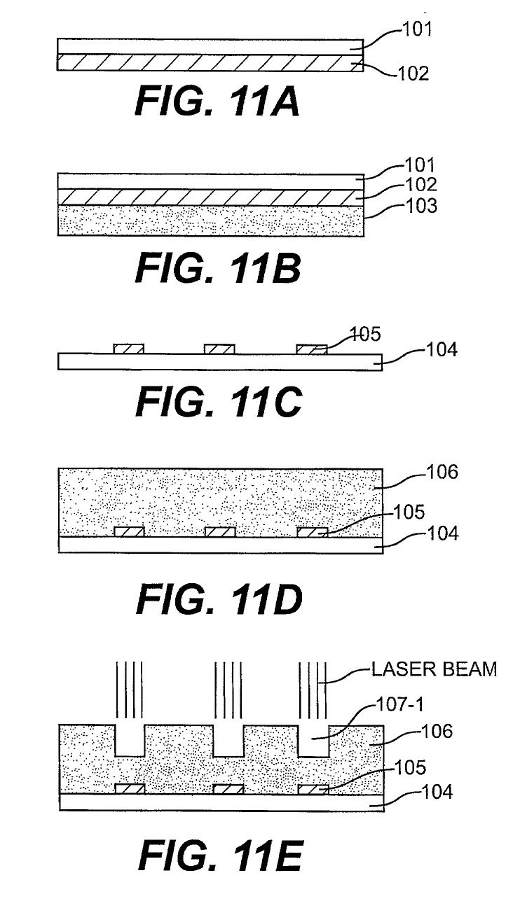

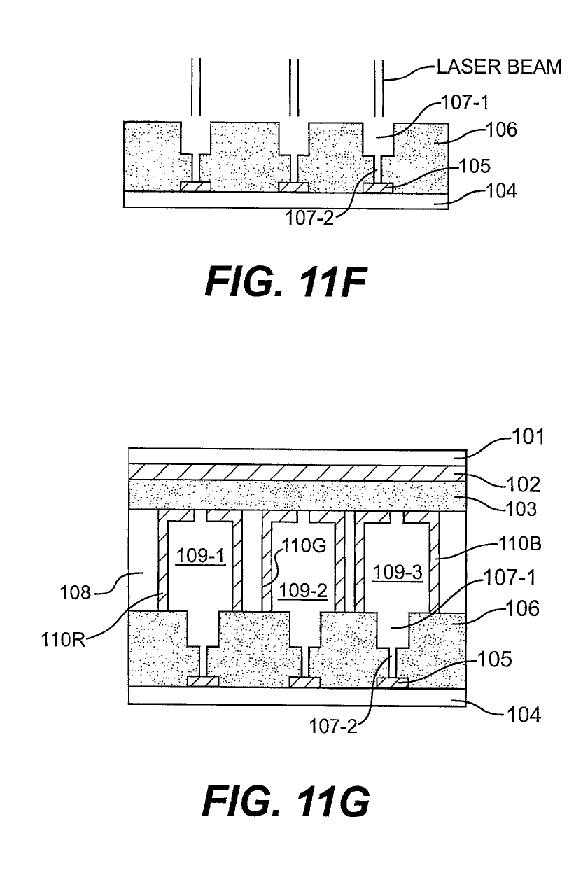

Referring initially to FIG. 11A, the capillary discharge plasma display panel consists of front and rear substrates (101, 104). A first metal electrode (102) is formed on the front substrate (101). The first metal electrode (102) is formed of indium tin oxide (ITO) in order to pass the light through the front substrate (101).

In FIG. 11B, a first dielectric layer (103) is formed to cover the first metal electrode (102) and separates the first metal electrode (102) from discharge spaces (shown in FIG. 11G as the reference numerals 109-1, 109-2, 109-3). For example, lead oxide (PbO) may be the choice of material for the first dielectric layer (103).

On the rear substrate (104), one or more second metal electrode (105) is formed thereon and acts as a bus electrode in FIG. 11C. For example, the second metal electrode (105) is formed of silver (Ag).

A second dielectric layer (106) having a thickness of about 50 μm is formed on the rear substrate (104) including the second metal electrode (105), as shown in FIG. 11D.

In order to form a capillary in the second dielectric layer (106), the laser optics shown in FIG. 10 is used. In FIG. 11E, a first capillary (107-1) having a first opening of about 100 μm in a horizontal width and about 25 μm in a vertical depth is formed in the second dielectric layer (106) over the second metal electrode (105). In this process, the Krypton Fluoride (KrF) laser having a wavelength of 248 nm is employed using a laser fluence of about 1.8 to 2.2 J/cm² or higher and an ablation rate of about 0.111 μm/shot. A laser image of an array of holes having a diameter of about 500 μm is reduced by the objective 99 producing an array of holes with a diameter of 100 μm, which is substantially the same as the horizontal width of the first capillary (107-1).

In FIG. 10F, a mask containing holes of diameter of 250 μm is reduced by the objective 99 for forming a second capillary (107-2) having an opening of 50 μm within the first capillary (107-1) having an opening of 100 μm. Thereafter, the laser beam is aligned to the center of the first capillary (107-1). The second capillary (107-2) is formed within the boundary of the first capillary (107-1) using a laser fluence of about 1.8 to 2.2 J/cm² or higher and an ablation rate of about 0.167 μm/shot, thereby exposing the second metal electrode (105) to discharge spaces (109-1, 109-2, 109-3), shown in FIG. 11G.

In forming the first and second capillaries in the above-described embodiments, a relative ratio of each capillary in the vertical depth may be varied. For example, the ratio of the vertical depth for the first and second capillaries may be one of 1 to 1, 1 to 2, and 2 to 1. However, any ratio may be applied in the present invention as long as its ratio is different from each other.

Further, a protective layer (shown in FIG. 2 as the reference numeral 28) such as MgO may be deposited on the second dielectric layer (106). After the discharge spaces (109-1, 109-2, 109-3) is defined by forming barrier ribs (108), UV-visible conversion layers (110R, 110G, 110B), such as phosphor, are formed inside walls of the discharge spaces. Thereafter, a capillary discharge plasma display panel of the present invention is completed by bonding the front and rear substrates (101, 104) by a seal frame layer (not shown).

It will be apparent to those skilled in the art that various modifications and variations can be made in the capillary discharge plasma display panel having a capillary of double size openings and method of fabricating the same of the present invention without departing from the spirit or scope of the inventions. Thus, it is intended that the present invention covers the modifications and variations of this invention provided they come within the scope of the appended claims and their equivalents.

What is claimed is:

1. A capillary discharge plasma display panel, comprising:
first and second substrates;
a first electrode on the first substrate;
a first dielectric layer on the first electrode including the first substrate;
at least one second electrode on the second substrate;
a second dielectric layer on the second electrode including the second substrate, wherein the second dielectric layer has at least one capillary therein, and the capillary includes first and second openings and the first opening is greater than the second opening in a horizontal width; and
at least one discharge space between the first and second dielectric layers and directly adjacent to the first opening of the capillary, thereby exposing a portion of the second electrode to the discharge space through the first and second openings to generate a continuous plasma discharge from the capillary.

2. The plasma display panel according to claim 1, further comprising a magnesium oxide layer on the first and second dielectric layers.

3. The plasma display panel according to claim 1, further comprising at least a pair of barrier ribs to define the discharge space.

4. The plasma display panel according to claim 1, further comprising a UV-visible conversion layer on inner walls of the discharge space.

5. The plasma display panel according to claim 1, wherein the first and second openings of the capillary have a horizontal width in the ratio of about 2 to 1.

6. The plasma display panel according to claim 1, wherein the first and second openings of the capillary have a vertical depth in the ratio of about 1 to 1.

7. The plasma display panel according to claim 1, wherein the first and second openings of the capillary have a vertical depth in the ratio of about 1 to 2.

8. The plasma display panel according to claim 1, wherein the first and second openings of the capillary have a vertical depth in the ratio of about 2 to 1.

9. The plasma display panel according to claim 1, wherein the first and second openings in the capillary has a horizontal width of about 100 and 50 μm, respectively.

10. The plasma display panel according to claim 1, wherein the second dielectric layer has a thickness of about 50 μm.

11. The plasma display panel according to claim 1, wherein the continuous discharge is initiated by applying a voltage in the range of about 200 to 350 V at a discharge space pressure between 200 and 600 Torr.

12. The plasma display panel according to claim 1, wherein the continuous discharge is sustained by applying a voltage in the range of about 140 to 200 V at a discharge space pressure between 200 and 600 Torr.

13. The plasma display panel according to claim 12, wherein the voltage of 300 V generates a current in the range of about 7 to 10 at the discharge space pressure between 200 and 600 Torr.

14. A method of fabricating a capillary discharge plasma display panel, having a pair of first and second substrates facing into each other with a discharge space therebetween, the method comprising the steps of:
forming a first electrode on the first substrate;
forming a first dielectric layer on the first electrode including the first substrate;
forming at least one second electrode on the second substrate;
forming a second dielectric layer on the second electrode including the second substrate;
forming at least one first capillary in the second dielectric layer; and
forming at least one second capillary in the second dielectric layer, wherein the first capillary is directly connected to the second capillary and the first capillary has end openings greater than the second capillary, thereby exposing a portion of the second electrode to the discharge space.

15. The method according to claim 14, further comprising the step of forming a protective layer on the second dielectric layer.

16. The method according to claim 14, further comprising the step of forming a UV-visible conversion layer on inner walls of the discharge space.

17. The method according to claim 14, wherein the step of forming at least one first capillary is performed by a laser process.

18. The method according to claim 17, wherein the laser process is carried out under conditions of a laser fluence of at least 1.8 to 2.2 J/cm² and an ablation rate of about 0.111 μm/shot.

19. The method according to claim 14, wherein the step of forming at least one second capillary is performed by a laser process.

20. The method according to claim 19, wherein the laser process is carried out under conditions of a laser fluence of at least 1.8 to 2.2 J/cm² and an ablation rate of about 0.167 μm/shot.

21. The method according to claim 14, wherein the step of forming at least one first capillary includes the steps of:
reducing a laser beam size to substantially the same as the horizontal width of the first capillary; and
forming the first capillary in the second dielectric layer to have a desired vertical depth.

22. The method according to claim 14, wherein the step of forming at least one second capillary includes the steps of:
reducing a laser beam size to substantially the same as the horizontal width of the second capillary;
aligning the laser beam to substantially the center of the first capillary; and
forming the first capillary in the second dielectric layer to expose the portion of the second electrode.
